(19) United States
(12) Patent Application Publication
(10) Pub. No.: US 2009/0059915 A1
(43) Pub. Date: Mar. 5, 2009

(54) SYSTEM AND METHOD OF AUTOMATING USE OF A DATA INTEGRITY ROUTINE WITHIN A NETWORK

(75) Inventor: Matthew W. Baker, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/846,777

(22) Filed: Aug. 29, 2007

(51) Int. Cl. H04L 12/56

(52) U.S. Cl. 370/389

(57) ABSTRACT

A system and method of automating use of a data integrity routine within a network. In one form, a method of managing network communication can include initiating a first network quality inquiry within a packet-based communication protocol network using a network quality check routine of a packet-based communication protocol. The method can also include receiving a first network quality value in response to the first network quality inquiry. The method can further include activating a data integrity routine in response to comparing the first network quality value to a first network quality specification value. In another aspect, an information handling system can be operable to carry out the method.

### FIELD OF THE DISCLOSURE

This disclosure relates generally to information handling systems, and more particularly to a system and method of automating use of a data integrity routine within a network.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can be configured to use a variety of hardware and software components that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a block diagram of a digest control system according to one aspect of the disclosure;

FIG. 3 illustrates a flow diagram of a method of managing network communication according to one aspect of the disclosure; and

FIG. 4 illustrates a block diagram of communicating network according to one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a wireless communication device, a diskless computer system, a thin client, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

In one embodiment, a method of managing network communication is disclosed. The method can include initiating a first network quality inquiry within a packet-based communication protocol network using a network quality check routine of a packet-based communication protocol. The method can also include receiving a first network quality value in response to the first network quality inquiry. The method can further include activating a data integrity routine in response to comparing the first network quality value to a first network quality specification value.

In another form, an information handling system is disclosed. The information handling system can include a first communication module operable to communicate across a network using a packet-based communication protocol. The information handling system can also include an information source coupled to the first communication module. The information source can output information including a first unit size value operable to be greater than a packet size limit of the packet-based communication protocol, thus resulting in multiple packets to transmit a unit of data. The information handling system can also include a network performance detection module operably coupled to the communication module. In one form, the network performance detection module can be operable to determine a network quality of the network to communicate the information over the network using the packet-based communication protocol and a data integrity routine.

According to a further aspect, a method of communicating information using a network is disclosed. The network can include communicating a login value from a source to a destination, and receiving a response at the source to an ICMP function communicated from the source to the destination. The method can also include activating a data integrity routine at the source and the destination in response to an ICMP value received at the source. The method can also include communicating information between the source and the destination using a packet-based communication protocol, and receiving the information at the destination. The method can further include processing the information using the data integrity routine.

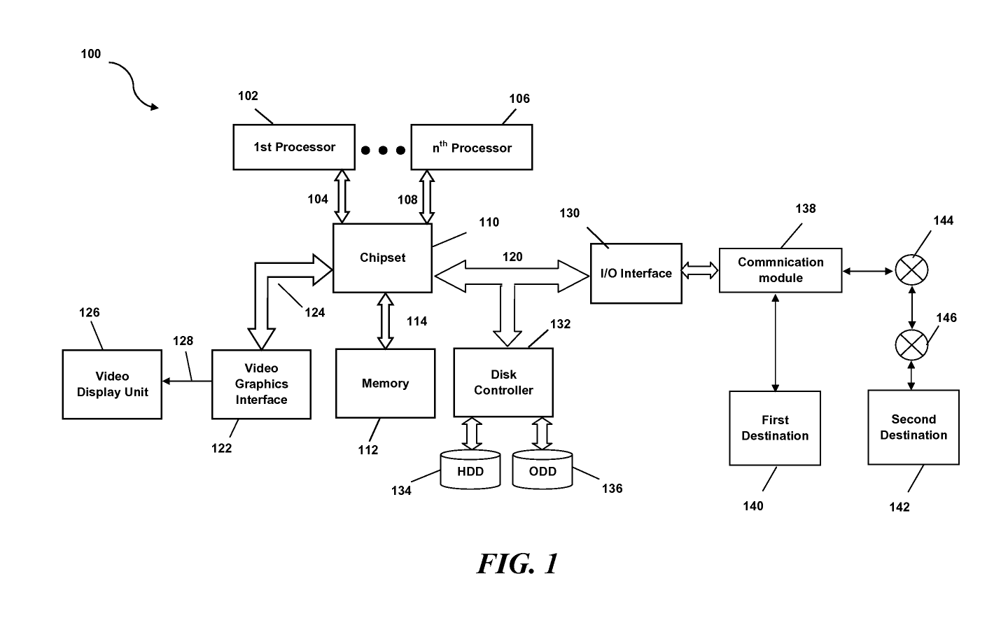

FIG. 1 illustrates a block diagram of an exemplary embodiment of an information handling system, generally designated at 100. In one form, the information handling system 100 can be a computer system such as a server. As shown in FIG. 1, the information handling system 100 can include a first physical processor 102 coupled to a first host bus 104 and can further include additional processors generally designated as physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and can allow for simultaneous processing of multiple processors and support the exchange of information within information handling system 100 during multiple processing operations.

According to one aspect, the chipset 110 can be referred to as a memory hub or a memory controller. For example, the chipset 110 can include a dedicated bus to transfer data between first physical processor 102 and the n^{th} physical processor 106. For example, the chipset 110 including a chipset that can include a memory controller hub and an input/output (I/O) controller hub. As a memory controller hub, the chipset 110 can function to access the first physical processor 102 using first bus 104 and the n^{th} physical processor 106 using the second host bus 108. The chipset 110 can also be used as a memory interface for accessing memory 112 using a memory bus 114. In a particular embodiment, the buses 104, 108, and 114 can be individual buses or part of the same bus. The chipset 110 can also include bus control and can handle transfers between the buses 104, 108, and 114.

According to another aspect, the chipset 110 can include an application specific chipset that connects to various buses, and integrates other system functions. For example, the chipset 110 can include using an Intel® Hub Architecture (IHA) chipset that can also include two parts, a Graphics and AGP Memory Controller Hub (GMCH) and an I/O Controller Hub (ICH). For example, an Intel 820E, an 815E chipset, an Intel 975X chipset, an Intel G965 chipset, available from the Intel Corporation of Santa Clara, Calif., or any combination thereof, can be used as at least a portion of the chipset 110. The chipset 110 can also be packaged as an application specific integrated circuit (ASIC).

In one form, the chipset 110 can be coupled to a video graphics interface 122 using a third bus 124. In one form, the video graphics interface 122 can be a Peripheral Component Interconnect (PCI) Express interface operable to content to display within a video display unit 126. Other graphics interfaces may also be used. The video graphics interface 122 can output a video display output 128 to the video display unit 126. The video display unit 126 can include one or more types of video displays such as a flat panel display (FPD), cathode ray tube display (CRT) or other type of display device.

The information handling system 100 can also include an I/O interface 130 that can be connected via an I/O bus 120 to the chipset 110. The I/O interface 130 and I/O bus 120 can include industry standard buses or proprietary buses and respective interfaces or controllers. For example, the I/O bus 120 can also include a PCI bus or a high speed PCI-Express bus. In one embodiment, a PCI bus can be operated at approximately 66 MHz and a PCI-Express bus can be operated at more than one (1) speed (e.g. 2.5 GHz and 5 GHz). PCI buses and PCI-Express buses can comply with industry standards for connecting and communicating between various PCI-enabled hardware devices. Other buses can also be used in association with, or independent of, the I/O bus 120 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the I/O bus 120 that can be operable as a PCI bus, and activities for the video graphics interface 122. The Northbridge portion can also communicate with the first physical processor 102 using first bus 104 and the second bus 108 coupled to the n^{th} physical processor 106. The chipset 110 can also include a Southbridge portion (not illustrated) of the chipset 110 and can handle I/O functions of the chipset 110. The Southbridge portion can manage the basic forms of I/O such as Universal Serial Bus (USB), serial I/O, audio outputs, Integrated Drive Electronics (IDE), and ISA I/O for the information handling system 100.

The information handling system 100 can further include a disk controller 132 coupled to the I/O bus 120, and connecting one or more internal disk drives such as a hard disk drive (HDD) 134 and an optical disk drive (ODD) 136 such as a Read/Write Compact Disk (R/W CD), a Read/Write Digital Video Disk (R/W DVD), a Read/Write mini-Digital Video Disk (R/W mini-DVD), or other type of optical disk drive.

In one form, the information handling system 100 can include a communication module 138 coupled to the I/O interface 130. The communication module 138 can be configured to communicate via a network such as the Intranet, the Internet, a local area network (LAN), a wide area network (WAN), or various other network types of networks. The communication module 138 can be coupled to one or more destinations that can include a first destination 140, a second destination 142, or any number of other destinations as desired. In one form, the second destination 142 can be coupled to the communication module via a first network interconnect 144 and a second network interconnect 146.

During operation, the information handling system 100 can communicate information from a data source, such as the HDD 134, the ODD 136, or another data source remote to the information handling system 100. In one form, the communication module 138 can communicate information using a packet-based communication protocol to a destination. Prior to communicating with a destination, the communication module 138 can determine a network quality of the network between the information handling system 100 and a destination. For example, the communication module 138 or other resource of the information handling system 100, can determine a network quality of a network between the information handling system 100 and a destination, such as the first destination 140. For example, the communication module 138 can determine a latency, or the amount of time (e.g. 5 milliseconds, 8 milliseconds, etc.) to communicate a specific size data packet, between the information handling system 100 and the first destination 140. In another form, the number of network interconnects, data routings, hops, etc. can be determined between the information handling system 100 and a destination. For example, the information handling system 100 can communicate information to the second destination 142 via the first interconnect 144 and the second interconnect 146. As such, a “hop count” of two (2) can be determined prior to communicating the information. Using the latency value and the “hop count” value, the communication module 138 can determine a communication mode, processing routine, encryption, error verification, or various other routines or method to employ in association with communicating information from the information handling system 100 to a destination. For example, if the latency value of the network, the hop count, or combinations thereof, exceed a specification to communicate information, the communication module 138 can employ an error detection routine to verify receipt of the information communicated between the information handling system 100 and a specific destination.

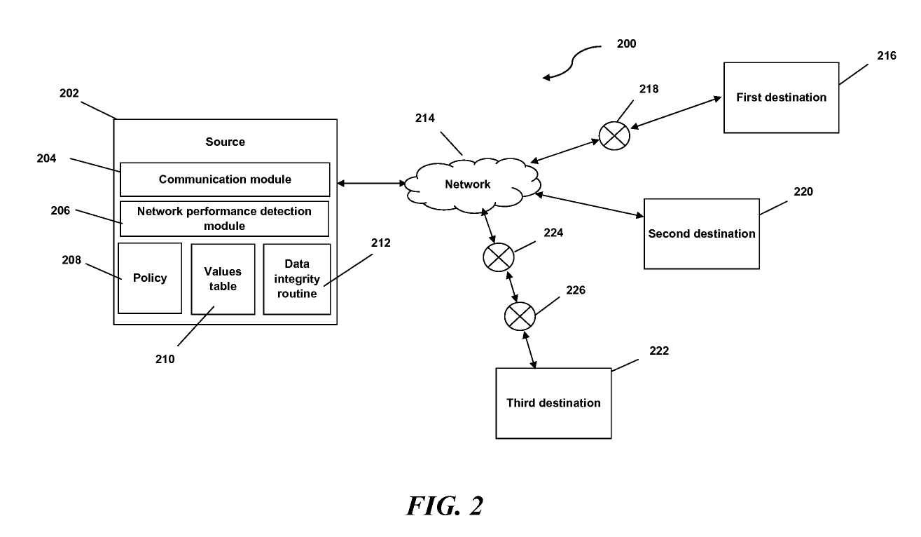

FIG. 2 illustrates a block diagram of a digest control system, illustrated generally at 200. The digest control system 200 can include a source 202, operable to access and communicate information via a network 214. In one form, the source 202 can be configured as information handling system 100 illustrated in FIG. 1 or various other types of information handling systems that can be configured to communicate with the network 214. In one form, the source 202 can include a communication module 204, a network performance detection module 206, a policy 208, a value table 210, and a data integrity routine 212. The source 202 can be coupled via the network 214 to one destination, or combinations of multiple destinations as desired. In one form, the source 202 can be employed as a server 202 that can access and server information from one or more data sources to one or more destinations. For example, the source 202 can be coupled to the first destination 216 via the first network interconnect 218. The source 202 can also be coupled to a second destination 220. The source 202 can further be coupled via the network 214 to a third destination 222 via a second interconnect 224 and a third interconnect 226. Other destinations can also be accessed as desired.

During operation, the source 202 can initiate communicating information to a destination such as the first destination 216. In one form, a packet-based network protocol can be used to communication information from the source 202 to the first destination 216. Additionally, the source 202 can access information from a data source via a network, such as an iSCSI network or other voluminous communication network, and a resource operable to store, transfer, or process data across an iSCSI network. iSCSI includes a standardized communication protocol that can enable communication of large blocks or data, data files, etc. that can exceed a standard packet size of an IP communication protocol. As such, iSCSI allows for dividing up the file or block of data into portions or PDUs with each PDU including portions of the data block or data file. Each PDU can then be communicated as a data packet to a destination and reassembled or combined to form the data block or data file as desired. In some forms, data communicated using iSCSI can include a unit size that can be greater than the unit size used within packet-based network to communicate data between the source 202 and a destination.

According to one aspect, the source 202 can employ use of a network performance detection module 206 to determine a network quality of a network connection between a source and a destination. For example, the network performance detection module 206 can initiate an ICMP function, such as a “ping” function or a “traceroute” function, to determine a network latency value or hop value between the source 202 and the first destination 216. The network performance detection module 206 can also employ a hop function using to determine the number of hops between the source 202 and the first destination 216. Upon receiving a returned latency value, the source 202 can compare the latency value to a value within the values table 210 stored within a memory of the source 202. For example, the values table 210 can include one or more network quality specification values of an expected performance of the network between the source 202 and the first destination 216. Upon receiving a response to one or more functions communicated between the source 202 and a destination, the returned values can be compared to the network quality specification values within the values table 210.

In one form, if the information to be communicated from the source 202 to the first destination 216 includes a specific format, such as iSCSI, and upon comparing the returned values from the first destination 216, the source can determine if the iSCSI Header and/or Data Digest routines (iSCSI specific data integrity routines) data integrity routine 212 should be used. For example, the data integrity routine 212 can be employed at the source 202 and the first destination 216, if the network quality is less than desired to communicate the iSCSI information. In this manner, one or more of the iSCSI information packets that can be lost or corrupt during communication across the network 214 can be resent. In one form, the data integrity routine 212 can include activating a data redundancy check, such as a 32-bit cyclical redundancy check (CRC) or other data verification check, that can be initiated at the source 202 based on a network quality determined at the source 202. As such, a data integrity routine 212 can be automatically activated by comparing the network quality to a network quality specification stored within the values table 210.

In one form, the digest control system 200 can employ the policy 208 to manage communication of information from the source 202 and a destination. For example, the policy can be updated by an external source such as a system administrator or network manager and communicated to the source 202. The policy 208 can include one or more entries to enable or disable use of the data integrity routine 212, the network performance detection module 206, the values table, 210, and other resource that may be available to the source 202. In one form, the policy 208 can be stored within a memory device (not illustrated) and accessed during an initialization routine of the source 202 to establish an operating environment of the source 202. Additionally, the policy 208 can also be used to initiate updates to the values table 210, the network performance detection module 206, or various other portions of the source 202 that can be updated as desired.

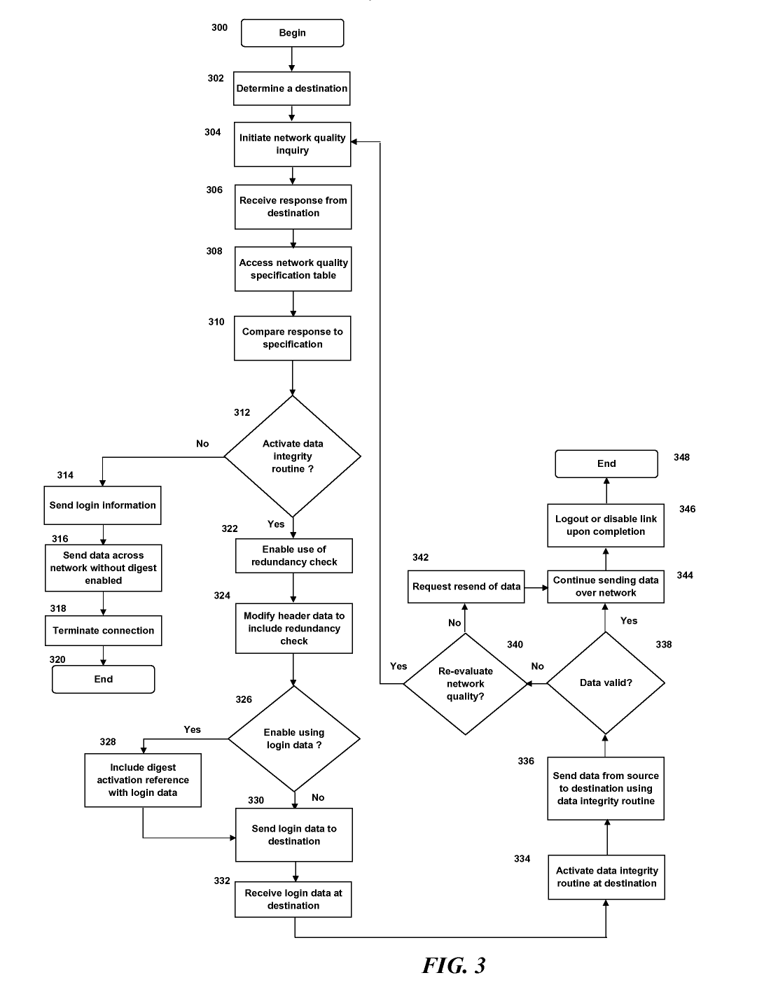

FIG. 3 illustrates a flow diagram of a method of controlling network digests within an information handling system according to one aspect of the disclosure. FIG. 3 can be employed in whole, or in part, by the information handling system 100 depicted in FIG. 1, the system 200 described in FIG. 2, or any other type of system, controller, device, module, processor, or any combination thereof, operable to employ all, or portions of, the method of FIG. 3. Additionally, the method can be embodied in various types of encoded logic including software, firmware, hardware, or other forms of digital storage mediums, computer readable mediums, or logic, or any combination thereof, operable to provide all, or portions, of the method of FIG. 3.

The method begins generally at block 300. At block 302, a destination to communicate information can be determined. For example, a source can be coupled to a destination using a communication network operable to communicate information using a packet based communication protocol such as an IP protocol. Additionally, the source can be coupled to a data source that can communicate information that can exceed a standard packet size to communicate information using an IP network. For example, an iSCSI communication network protocol can be used in association with a source to communicate information.

Upon determining a destination, the method can proceed to block 304 and initiates an inquiry into one or more network qualities prior to communicating the information. For example, a network quality can be determined by communicating a message to the destination and receiving a network quality response from the destination. The network quality inquiry can include various types of performance metric requests that can be used to determine various network qualities including, but not limited to, an amount of time to respond to a ping request or other function that can be used to determine a length of time to communicate a specific amount of information. A network quality inquiry can also include determining the number of network interconnects or hops may be encountered between a source and a destination. For example, one method of determining the number of hops can include sending a inquiry and receiving one or more responses that can include network addresses, response times, number of responses, etc. The response can be used to determine a hop count and latency associated with communicating information from a source to a destination.

In another form, an Internet Control Message Protocol (ICMP) routine can be used to access a network quality of a network link. For example, an ICMP routine can include a message control and error-reporting protocol that can be used between a host server or source and a gateway to a network such as the Internet. ICMP can employ use of Internet Protocol (IP) datagrams, or an independent entity of data, that can carry sufficient information to be routed from a source to a destination. In one form, the datagram can be communicated without a reliance on earlier exchanges between the source and the destination and the transporting network.

Upon sending an inquiry, the method can proceed to block 306 and a response to a network quality inquiry can be received. For example, a network ping value and one or more network hop values can be received from the destination. Upon receiving the network quality inquiry response, the method can proceed to block 308, and the obtained values can be compared to one or more network quality specification values stored within a values table that can be accessed at the source. For example, a hop count value and a latency value can be compared to a network quality specification to determine if a digest routine should be used or enabled.

In one form, if at decision block 312, the digest routine should not be activated or enabled, the method can proceed to block 314 and login information can be communicated to the destination if desired, to validate access of from the source to the destination. The method can then proceed to block 316, and data or information can be sent from the source to the destination without using a digest routine. The method can the proceed to block 318, and the network connection can be terminated. In one form, the network connection can be terminated by having the source logout. In other forms, the network connection can be terminated upon receipt of a final data packet communicated by the source. Various other forms of disconnecting can also be used.

If at decision block 312, the digest routine should be activated or enabled, the method can proceed to block 322 and use of the digest routine can be enabled. For example, a redundancy check can be enabled to be used with the information to be communicated to the destination. In one form, a 32-bit cyclical redundancy code (CRC) can be used with the data to be communicated from the source to the destination. As such, the information to be communicated can be processed to include a 32-bit CRC code with the data packets to be communicated to the destination.

Upon enabling use of a redundancy check, the method can proceed to block 324, and header data of the data packets to be communicated can be modified to include a reference to the enabled redundancy check. The method can then proceed to decision block 326, and determines if the digest routine should be enabled using login data communicated to the destination. For example, a destination can be operable to receive one or more parameters with login data and, the source can communicate the information to the destination to activate a digest routine at the destination. As such, if data should not be included with the login data, the method can proceed to block 330.

If at decision block 326, the login data is to include one or more parameters or values to activate the digest routine at the destination, the method can proceed to block 328 and information to enable a digest routine can be included with the login data. The method can then proceed to block 330, and the login data can be communicated to the destination. At block 332, the login data can be received at the destination, and the digest routine can be activated at the destination at block 334 upon validating the login data. The method can then proceed to block 336, and one or more data packets can be communicated from the source to the destination using the activated or enabled digest routine. For example, one or more packets of data can be communicated to the destination and the destination can verify or validate the data packets. For example, a CRC data verification routine can be employed to ensure data sent from a data source, such as an iSCSI source, may be valid, complete, etc.

As such, the method can then proceed to decision block 338, and if the received data is invalid, the method can proceed to decision block 340 and determines if the network should be re-evaluated. For example, a network connection or topology may have been modified, or the performance of a portion of all of the network may have decreased due to network congestion, traffic, etc. As such, if at decision block 340 the network should be re-evaluated, the method can proceed to block 304 and repeat. If at decision block 340, the network should net be re-evaluated, the method can proceed to block 342 and a request to resend data can be sent to the source.

At block 344, the method can continue to send data over the network and upon completion of sending the data from the source to the destination, the method can proceed to block 346 and the network connection can be terminated. Upon termination or logging out, the digest routine can be disabled at the destination. The method can then proceed to block 348 and the method can end.

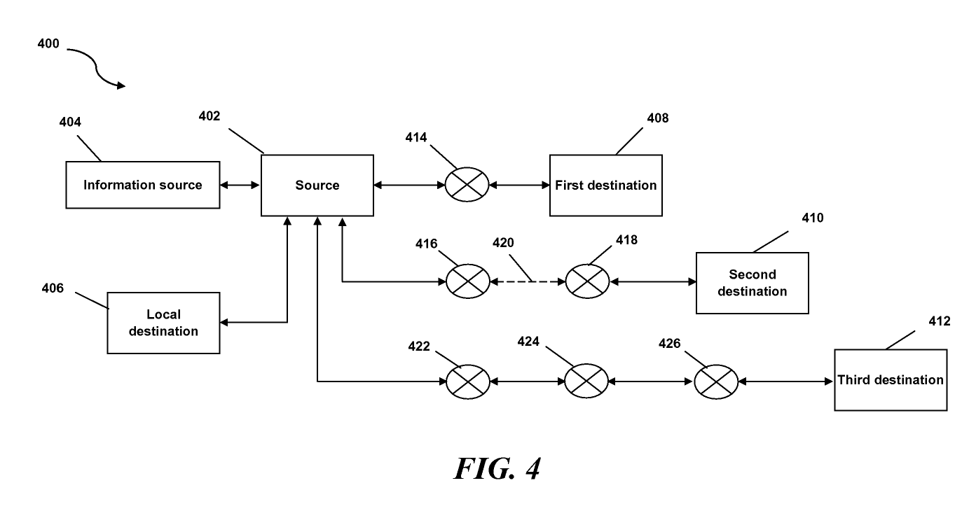

FIG. 4 illustrates a block diagram of a communication network, illustrated generally at 400, according to one aspect of the disclosure. The network 400 can include a source 402 operable to be coupled to an information source 404. The source 402 can also be coupled to a local destination 406 via a local area network. The source 402 can further be coupled to one or more of a first destination 408, a second destination 410, and a third destination 412. The first destination 408 can be coupled using a local network including a first network interconnect 414 such as a router, hub, switch, and the like. Similarly, the second destination can be coupled to the source 402 via a second network interconnect 416 and a third network interconnect 418. In one form, the second network interconnect 416 and the third network interconnect 418 can be coupled via a local or long-range wireless network 420. The source 402 can also be coupled to the third source 412 via a fifth network interconnect 422, a sixth network interconnect 424, and a seventh network interconnect 426.

During operation, the source 402 can be operable to communicate with multiple destinations and can determine a performance characteristic of a network connection to each destination. For example, the source 402 can determine include a performance specification initiated by a policy that can enabled an iSCSI digest routine if a hop count of greater than two (2) may be determined or latency of greater than twenty (20) milliseconds may be determined. As such, if the first destination 408 returns a hop count value of one (1), and a latency value of ten (10) milliseconds, the iSCSI digest routine may not be enabled. Additionally, if the second destination 410 returns a hop count value of two (2), and a latency value of thirty (30) milliseconds, the iSCSI digest routine can be enabled when connected to the second destination 410. Similarly, if the third destination 412 returns a hop count value of three (3) and a latency value of fifteen (15) milliseconds, the iSCSI digest routine can be enabled. As such, various combinations of values can be received from multiple destinations and a digest routine activated as desired.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method of managing a network communication comprising:
initiating a first network quality inquiry within a packet-based communication protocol network using a network quality check routine of a packet-based communication protocol;
receiving a first network quality value in response to the first network quality inquiry; and
activating a data integrity routine in response to comparing the first network quality value to a first network quality specification value.

2. The method of claim 1, further comprising:
maintaining use of the data integrity routine over a period of time;
reevaluating the packet-based communication protocol network; and
altering use of the data integrity routine in response to the reevaluating.

3. The method of claim 1, further comprising:
accessing a table including the first network quality specification value;
comparing the first network quality value to the first network quality specification value; and
initiating activation of the data integrity routine in response to the comparison.

4. The method of claim 1, further comprising:
enabling a use of a first data integrity routine at a source in response to the first network quality value;
enabling a use of second data integrity routine at a destination in response to the first network quality value;
communicating an information packet using the first data integrity routine within the packet-based protocol network; and
wherein the information packet includes a network digest reference that can be processed using to the second data integrity routine at the destination.

5. The information handling system of claim 1, further comprising:
activating an Internal Control Message Protocol (ICMP) ping function at a source coupled to the packet-based protocol network;
receiving a ICMP ping value in response to the ICMP ping function, the ICMP ping value communicated from the destination; and
comparing the ICMP ping value to a latency specification value stored within an activation table at the source.

6. The method of claim 5, further comprising:
activating an ICMP trace route function at the source;
receiving an ICMP trace route value in response to the ICMP trace route function, the ICMP trace route value communicated from a first destination within the packet-based protocol network; and
comparing the ICMP trace route value to a trace route specification value within the activation table at the source.

7. The method of claim 6, further comprising:
determining the ICMP trace route value is greater than the trace route specification value;
determining the ICMP ping values is greater than the latency specification; and
initiating activation of the data integrity routine.

8. The method of claim 7, further comprising:
communicating a data integrity routine reference with a login value from the source to the destination;
enabling access to the destination using the login value; and
activating use of the data integrity routine using the data integrity routine reference at the destination.

9. The method of claim 1, further comprising:
accessing a policy including a reference to initiate the first network quality check inquiry; and
activating the first network quality check inquiry using the policy.

10. The method of claim 9, further comprising:
receiving the policy at a source, wherein the policy is maintained external to the source; and
updating a table within a memory of the source, wherein the table includes at least one network quality specification value.

11. An information handling system comprising:
a first communication module operable to communicate across a network using a packet-based communication protocol;
an information source coupled to the first communication module and operable to output information including a first unit size value operable to be greater than a packet size limit of the packet-based communication protocol; and
a network performance detection module operably coupled to the communication module, wherein the network performance detection module is operable to determine a network quality of the network to communicate the information over the network using the packet-based communication protocol and a data integrity routine.

12. The information handling system of claim 11, further comprising:
a first source including the first communication module;
a first destination including a second communication module; and
wherein the first communication module and the second communication module are operable to communicate the information using the data integrity routine.

13. The information handling system of claim 12, further comprising:
wherein the first communication module includes a first iSCSI enabled communication module; and
wherein the data source includes an iSCSI enabled data source.

14. The information handling system of claim 12, further comprising the source operable to:
disable the data integrity routine in response to detecting a second unit size value that is less than the first unit size value;
communicate the information without using the data integrity routine;
detect an increased unit size greater than the second unit size value communicated from of a second information source;
determine the network quality exceeds a network quality specification value; and
activate the data integrity routine.

15. The information handling system of claim 11, further comprising:
wherein the first communication module is operable to be coupled to a destination via a wide area network (WAN) operable to employ the packet-based communication protocol; and
wherein the network performance detection module is operable to determine a latency and a hop count between the first communication module and the destination.

16. The information handling system of claim 15, further comprising the network performance detection module operable to initiate use of the data integrity routine at the destination in response to determining the latency and the hop count.

17. The information handling system of claim 11, further comprising:
wherein the first communication module is operable to be connected to the information source via a local area network (LAN); and
a destination operable to be coupled to the first communication module via the LAN to access the information source.

18. A method of communicating information using a network comprising:
communicating a login value from a source to a destination;
receiving a response at the source to an ICMP function communicated from the source to the destination;
activating a data integrity routine at the source and the destination in response to an ICMP value received at the source;
communicating information between the source and the destination using a packet-based communication protocol;
receiving the information at the destination; and
processing the information using the data integrity routine.

19. The method of claim 18, further comprising:
validating the information using the data integrity routine at the destination;
requesting additional information in response to a first portion of the information being invalid; and
communicating the first portion of the information from the source to the destination in response to the request.

20. The method of claim 18, further comprising:
communicating an ICMP trace route function between the source and the destination;
communicating an ICMP ping function between the source and the destination;
initiating the data integrity routine in response to comparing a returned ICMP trace route value to a trace route specification value; and
initiating the data integrity routine in response to comparing a returned ICMP ping value to a latency specification.
